(19) United States
(12) Patent Application Publication
(10) Pub. No.: US 2013/0246617 A1
(43) Pub. Date: Sep. 19, 2013

(54) METHOD AND SYSTEM FOR PROCESSING NETWORK DATA

(71) Applicant: TENCENT TECHNOLOGY (SHENZHEN) COMPANY LIMITED, (US)

(72) Inventor: ZHIHAO ZHENG, Shenzhen (CN)

(73) Assignee: TENCENT TECHNOLOGY (SHENZHEN) COMPANY LIMITED, Shenzhen (CN)

(21) Appl. No.: 13/874,750

(22) Filed: May 1, 2013

Related U.S. Application Data
(63) Continuation of application No. PCT/CN2011/079747, filed on Sep. 16, 2011.

(30) Foreign Application Priority Data
Nov. 11, 2010 (CN) 201010540385.2

(51) Int. Cl. H04L 12/26

(52) U.S. Cl. CPC H04L 43/04
USPC 709/224

(57) ABSTRACT

A method is provided for processing network data. The method includes detecting a network status, determining whether the network status meets one or more normal operating conditions, and entering an offline mode when it is determined that the network status does not meet the normal operating conditions. The method also includes detecting a user instruction, and determining whether or not the user instruction is a submission instruction for submitting user data to be submitted. Further, the method includes obtaining the user data to be submitted and caching the user data as offline data when it is determined that the user instruction is a submission instruction, and continuing detecting the user instruction when it is determined that the user instruction is not a submission instruction.

### CROSS-REFERENCES TO RELATED APPLICATIONS

The application is a continuation of PCT Patent Application No. PCT/CN2011/079747, filed on Sep. 16, 2011, which claims priority of Chinese Patent Application No. 201010540385.2, filed on Nov. 11, 2010, the entire contents of all of which are hereby incorporated by reference.

### FIELD OF THE INVENTION

The present invention generally relates to communication technologies and, more particularly, to a method for processing network data and a system for processing network data.

### BACKGROUND

As smart phones, personal digital assistants (PDAs) and other mobile devices become increasingly popular, networking services applied on mobile devices are growing. Specific network services need to be processed by specific clients, which include applications installed on smart phones.

One type of network services is to provide one-way download services, such as a mobile phone music player, which can download music from a server and can also automatically search and download lyrics while playing music. Another type of services provides users with storage and user data organization functionalities, such as mobile phone QQ space, where the users edit logs and photos, etc., on the mobile phone clients, and submit for publication after the editing is completed.

For the latter type of services, in case of poor network condition, when the user sends content edited on the client to the server, the server may be unable to respond for a long time. Further, when a network connection is disconnected, the user has to stop submitting. Due to lack of corresponding handling mechanisms, the user may lose data easily in such a situation.

The disclosed methods and systems are directed to solve one or more problems set forth above and other problems.

### BRIEF SUMMARY OF THE DISCLOSURE

One aspect of the present disclosure includes a method for processing network data. The method includes detecting a network status, determining whether the network status meets one or more normal operating conditions, and entering an offline mode when it is determined that the network status does not meet the normal operating conditions. The method also includes detecting a user instruction, and determining whether or not the user instruction is a submission instruction for submitting user data to be submitted. Further, the method includes obtaining the user data to be submitted and caching the user data as offline data when it is determined that the user instruction is a submission instruction, and continuing detecting the user instruction when it is determined that the user instruction is not a submission instruction.

Another aspect of the present disclosure includes a system for processing network data. The system includes a client and a server, and the client exchanges network data with the server through a network. The client includes a network detecting module, a mode conversion module, and an instruction processing module. The network detecting module is configured to detect a network status. The mode conversion module is configured to determine whether the network status meets one or more normal operating conditions and, when it is determined that the network status does not meet the normal operating conditions, to enter an offline mode. Further, the instruction processing module is configured to detect a user instruction and to determine whether or not the user instruction is a submission instruction for submitting user data to be submitted. The instruction processing module is also configured to, when it is determined that the user instruction is a submission instruction, obtain the user data to be submitted and to cache the user data as offline data. The instruction processing module is also configured to, when it is determined that the user instruction is not a submission instruction, continue detecting the user instruction.

Other aspects of the present disclosure can be understood by those skilled in the art in light of the description, the claims, and the drawings of the present disclosure.

### BRIEF DESCRIPTION OF THE DRAWINGS

FIG. 1 illustrates an exemplary method for processing network data consistent with the disclosed embodiments;

FIG. 2 illustrates a processing flow for determining whether offline mode is enabled consistent with the disclosed embodiments;

FIG. 3 illustrates another exemplary method for processing network data consistent with the disclosed embodiments;

FIG. 4 illustrates a processing flow for determining whether to enable a manual synchronization mode consistent with the disclosed embodiments;

FIG. 5 illustrates a processing flow of a manual synchronization mode consistent with the disclosed embodiments;

FIG. 6 illustrates a system structure diagram for processing network data consistent with the disclosed embodiments;

FIG. 7 illustrates an exemplary environment incorporating certain disclosed embodiments; and

FIG. 8 illustrates a block diagram of an exemplary computer system consistent with the disclosed embodiments.

### DETAILED DESCRIPTION

Reference will now be made in detail to exemplary embodiments of the invention, which are illustrated in the accompanying drawings.

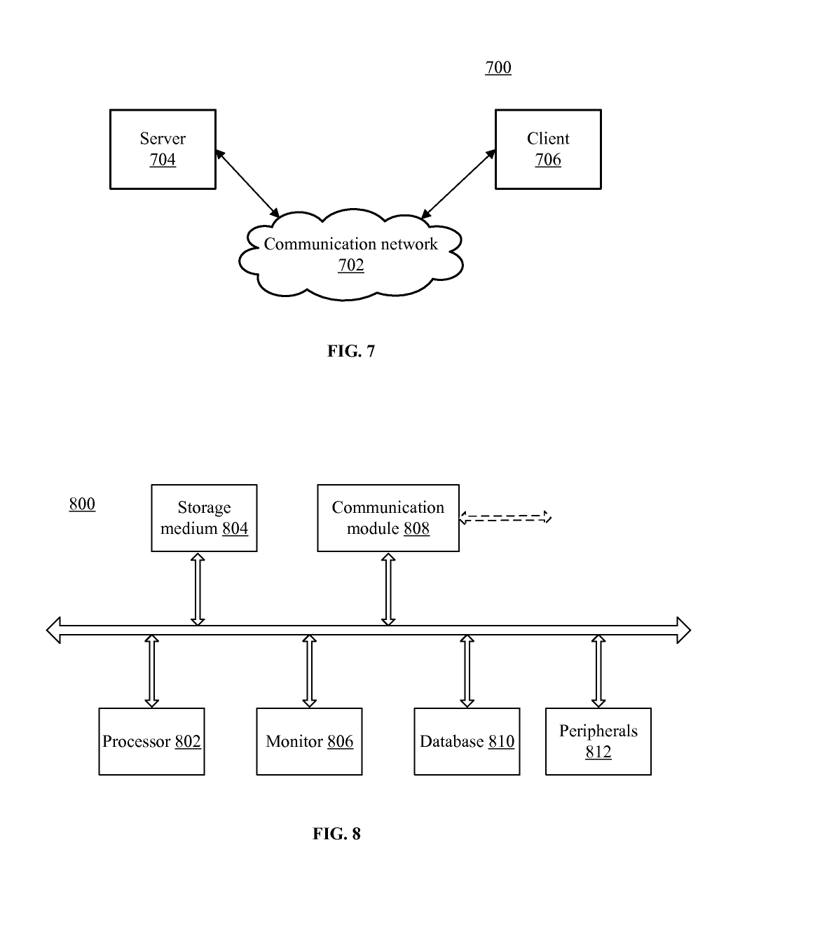

FIG. 7 illustrates an exemplary environment 700 incorporating certain disclosed embodiments. As shown in FIG. 7, environment 700 may include a server 704, a client 706, and a communication network 702. The server 704 and the client 706 may be coupled through the communication network 702 for information exchange, such as IM (instant message) communication. Although only one client 706 and one server 704 is shown in the environment 700, any number of clients 706 or servers 704 may be included, and other devices may also be included.

Communication network 702 may include any appropriate type of communication network for providing network connections to the server 704 and client 706 or among multiple servers 704 or clients 706. For example, communication network 702 may include the Internet or other types of computer networks or telecommunication networks, either wired or wireless.

A client, as used herein, may refer to any appropriate user terminal with certain computing capabilities, such as a smart phone, a personal computer (PC), a work station computer, a server computer, a hand-held computing device (tablet), a mobile phone, or any other user-side computing device. A client may also refer to any client-side software program running on the user terminal, such as a web browser on a smart phone, etc.

A server, as used herein, may refer one or more server computers configured to provide certain server functionalities, such as web browsing, database management, and search engines. A server may also include one or more processors to execute computer programs in parallel.

Server 704 and/or client 706 may be implemented on any appropriate computing platform. FIG. 8 shows a block diagram of an exemplary computer system 800 capable of implementing server 704 and/or client 706.

As shown in FIG. 8, computer system 800 may include a processor 802, a storage medium 804, a monitor 806, a communication module 808, a database 810, and peripherals 812. Certain devices may be omitted and other devices may be included.

Processor 802 may include any appropriate processor or processors. Further, processor 802 can include multiple cores for multi-thread or parallel processing. Storage medium 804 may include memory modules, such as ROM, RAM, flash memory modules, and erasable and rewritable memory, and mass storages, such as CD-ROM, U-disk, and hard disk, etc. Storage medium 804 may store computer programs for implementing various processes, when executed by processor 802.

Further, peripherals 812 may include I/O devices such as keyboard and mouse, and communication module 808 may include network devices for establishing connections through the communication network 702. Database 810 may include one or more databases for storing certain data and for performing certain operations on the stored data, such as database searching.

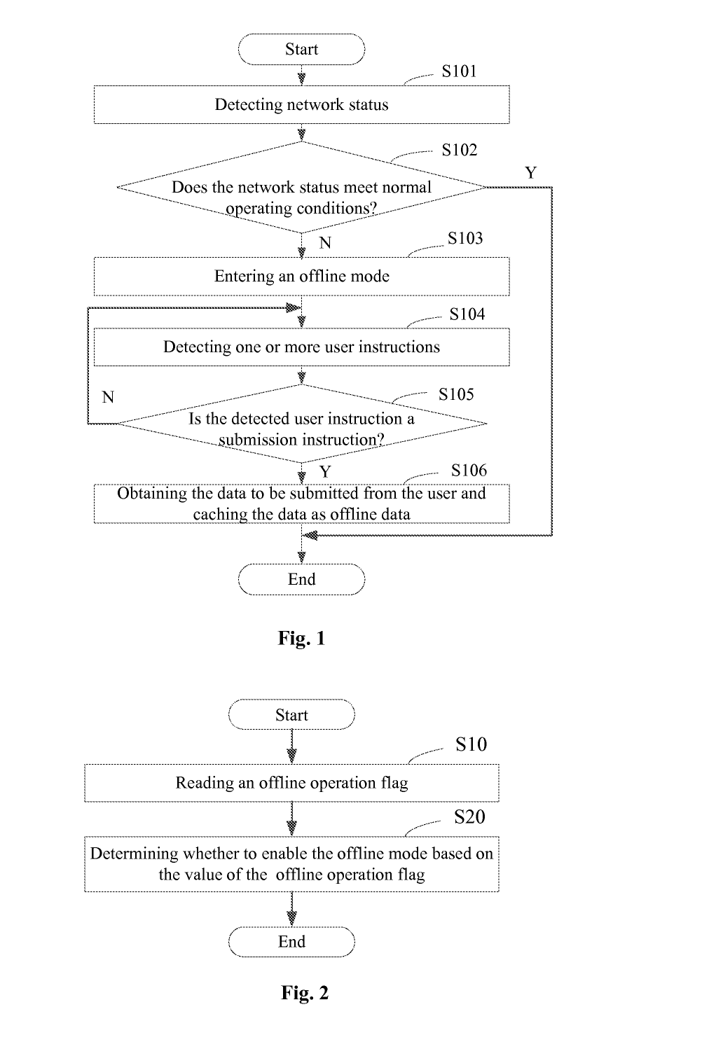

In operation, e.g., server 704 and/or client 706 may perform certain methods to process network data. FIG. 1 illustrates an exemplary method for processing network data consistent with the disclosed embodiments. As shown in FIG. 1, the method includes the following steps:

S101: detecting network status. Network status is a reflection of communication status between a client and a server. It may be detected by sending test packets from the client to the server. Server response time, packet loss, data transfer rate, and other parameters determine the network status. This step may be performed throughout the method and, therefore, a change of network status may be detected at the earliest time. This step may also be scheduled at a certain time interval, that is, once every reasonable period of time. Thus, network traffic can be saved. The time interval of the scheduled detection may be adjusted according to actual situations or particular applications.

S102: determining whether the network status meets normal operating conditions. A normal operating condition may be defined simply as the network being in a connected status, which may be determined based on whether the server responds to test data packets. However, in certain applications, there are also requirements for server response time and data transfer rate for a normal operating condition. In such case, a threshold value based determination can be used, such as whether the server response time is less than a preset threshold value; whether the data transfer rate is greater than a preset threshold data transfer rate; and so on. If it is determined that the network status does not meet the normal operating condition, S103 is performed.

S103: entering an offline mode. The offline mode is relative to a normal online mode. A same user instruction may cause different operations to be performed in different operating modes. For example, when in the normal online mode (i.e., under a normal operating condition), the user can send the data directly to the server. When in the offline mode, the data may need to be cached first, as in S106.

S104: detecting one or more user instructions. The user instruction refers to the instruction generated by user operations, such as a submission instruction for submitting data to be submitted, a refresh instruction for refreshing the current display interface, an exit instruction for exiting from the client, and so on. The user instructions are detected to determine corresponding operations.

S105: determining whether or not the detected user instruction is a submission instruction. If it is determined that the detected user instruction is a submission instruction, S106 is performed. Otherwise, S104 is performed. The submission instruction refers to the instruction for the user to submit the data, such as publishing logs, sending pictures, uploading audio or video, etc.

S106: obtaining the data to be submitted from the user and caching the data as offline data. The data to be submitted includes text, images, audio, video, etc. According to the client's application, each data type has its own corresponding properties. For example, when publishing a log in a Blog application, the log has a title, a body (which might contain pictures), a post or publication date, and blog categories, etc. When storing a picture (or photo), the picture (or photo) has a title, a description (notes), a post date, and photo albums categories, etc. Similarly, audio and video data also have similar properties. When the data to be submitted is cached as the offline data, the offline data is organized according to the data properties.

In certain embodiments, before entering the offline mode, it may be further determined whether to enable the offline mode. FIG. 2 illustrates a processing flow for determining whether offline mode is enabled consistent with the disclosed embodiments. As shown in FIG. 2, the process flow may include the followings.

S10: reading an offline operation flag. The offline operation flag is used to indicate whether the client enables the offline mode. In general, a Boolean variable may be used to store the value of the corresponding flag. The value of offline operation flag is set or configured based on requirements from the user. The client may provide an entry for such configuration, and the user selects whether to enable the offline mode and further sets the offline operation flag to a corresponding value.

S20: determining whether to enable the offline mode based on the value of the offline operation flag. When the offline operation flag is equal to 1, which indicates that the offline mode can be used, the offline mode can be enabled to perform appropriate offline operations. On the other hand, when the offline operation flag is equal to 0, which indicates that the client does not start offline operation functionalities, the offline mode cannot be used, and all operations are processed in the traditional mode (i.e., non-offline mode).

Accordingly, based on the user instructions, operations different from the operations in the online mode can be performed in the offline mode. Network data operations can still be performed in poor network condition or even when the network is disconnected, enabling smooth operations and improving user experience.

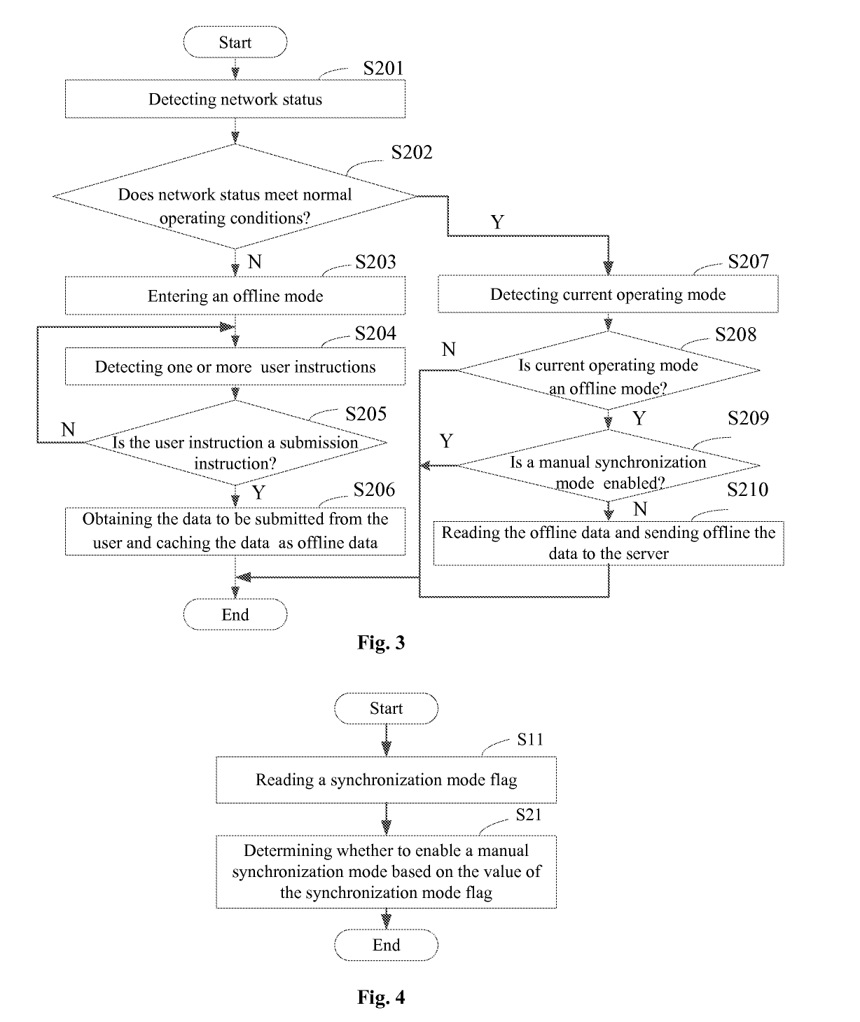

FIG. 3 illustrates another exemplary method for processing network data consistent with the disclosed embodiments. As shown in FIG. 3, the method includes the followings.

S201: detecting network status. Network status is a reflection of communication status between a client and a server. It may be detected by sending test packets from the client to the server. Server response time, packet loss, data transfer rate, and other parameters determine the network status. This step may be performed throughout the method and, therefore, a change of network status may be detected at the earliest time. This step may also be scheduled at a certain time interval, that is, once every reasonable period of time. Thus, network traffic can be saved. The time interval of the scheduled detection may be adjusted according to actual situations or particular applications.

S202: determining whether the network status meets normal operating conditions. A normal operating condition may be defined simply as the network being in a connected status, which may be determined based on whether the server responds to test data packets. However, in certain applications, there are also requirements for server response time and data transfer rate for a normal operating condition. In such case, a threshold value based determination can be used, such as whether the server response time is less than a preset threshold value; whether the data transfer rate is greater than a preset threshold data transfer rate; and so on. If it is determined that the network status meets the normal operating condition, S207 is performed. Otherwise, S203 is performed.

S203: entering an offline mode. The offline mode is relative to a normal online mode. A same user instruction may cause different operations to be performed in different operating modes. For example, when in the normal online mode (i.e., under a normal operating condition), the user can send the data directly to the server. When in the offline mode, the data may need to be cached first, as in S206.

S204: detecting one or more user instructions. The user instruction refers to the instruction generated by user operations, such as a submission instruction for submitting data to be submitted, a refresh instruction for refreshing the current display interface, an exit instruction for exiting from the client, and so on. The user instructions are detected to determine corresponding operations.

S205: determining whether or not the user instruction is a submission instruction. If the user instruction is a submission instruction, S206 is performed, otherwise S204 is performed.

S206: obtaining the data to be submitted from the user and caching the data as offline data. The data to be submitted includes text, images, audio, video, etc. According to the client's application, each data type has its own corresponding properties. For example, when publishing a log in a Blog application, the log has a title, a body (which might contain pictures), a post or publication date, and blog categories, etc. When storing a picture (or photo), the picture (or photo) has a title, a description (notes), a post date, and photo albums categories, etc. Similarly, audio and video data also have similar properties. When the data to be submitted is cached as the offline data, the offline data is organized according to the data properties.

S207: detecting the current operation mode. The operation mode of a client includes the previous described offline mode and online mode. S207 is a processing step after S202 determines that the network status meets the normal operating conditions, and a precedent step to offline data synchronization.

S208: determining whether the current operating mode is the offline mode. If the current operating mode is the offline mode, S209 is performed. Otherwise, the current method or process is completed. If the current network status meets the normal operating conditions and the current operating mode is in the offline mode, it indicates that the network status is recovered from abnormal operating conditions, and it is likely in need to synchronize the offline data. Otherwise, it indicates the network status has been under normal operating conditions, and no additional processing is needed.

S209: determining whether to enable a manual synchronization mode. If it is determined to enable a manual synchronization mode, the method or process is completed. Otherwise, S210 is performed. The manual synchronization mode is relative to an automatic synchronization mode, and is the mode under which the offline data is synchronized based on a manual synchronization instruction from the user. If the manual synchronization mode is enabled, the current method/process is completed. Based on the manual synchronization instruction from the user, the client may send the offline data to the server at any time. The manual synchronization mode is not always enabled. If the manual synchronization mode is not enabled, the automatic synchronization mode can be used, i.e., S210 is performed.

S210: reading the offline data and sending the offline data to the server. Synchronization may ensure the consistency of the data.

Details of S209 are illustrated in FIG. 4. As shown in FIG. 4, S209 further includes the followings.

S11: reading a synchronization mode flag. The synchronization mode flag is used to indicate whether the client enables a manual synchronization mode. In general, a Boolean variable can be used to store the value of the corresponding flag. The value of synchronization mode flag is set or configured based on requirements from the user. The client may provide an entry for such configuration, and the user selects whether to enable the synchronization mode and further sets the synchronization mode flag to a corresponding value.

S21: determining whether to enable the manual synchronization mode based on the value of the synchronization mode flag. When the synchronization mode flag is equal to 1, it indicates that the manual synchronization mode is enabled, and an automatic synchronization is not required. On the other hand, when the synchronization mode flag is equal to 0, it indicates that the client does not enable manual synchronization functionalities. The manual synchronization mode is not enabled, and an automatic synchronization is required.

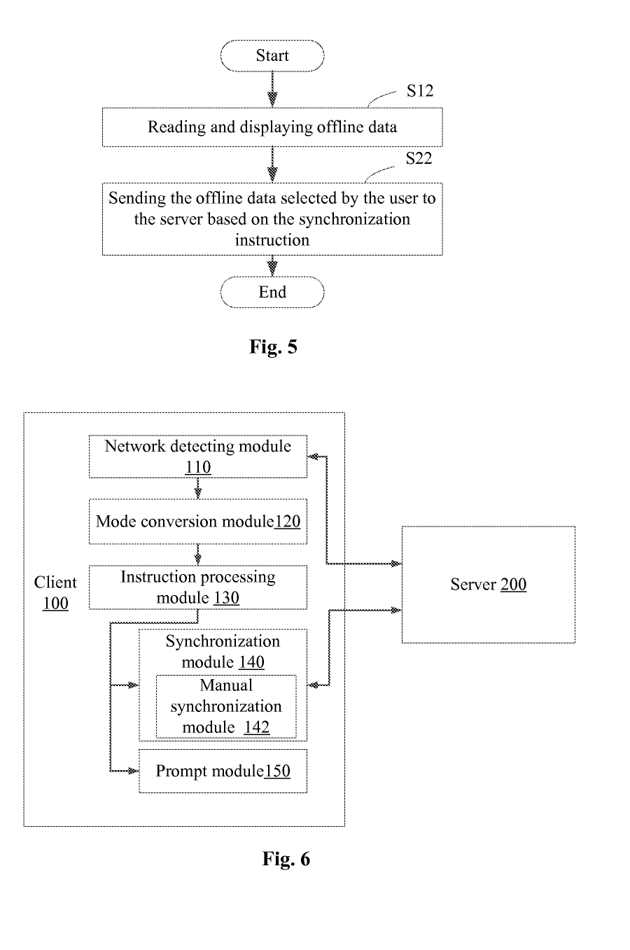

FIG. 5 illustrates a processing flow of a manual synchronization mode consistent with the disclosed embodiments. As shown in FIG. 5, the manual synchronization includes the followings.

S12: reading and displaying offline data. The user may submit data multiple times in the offline mode, generating multiple entries of offline data. All of such offline data are read and usually displayed a list format. In the manual synchronization mode, multiple entries of offline data may be displayed in a single page using the list format. Each entry of offline data is provided with a synchronization selection, which may generate a synchronization instruction when selected. The synchronization selection may be provided as a button corresponding to the offline data. The user clicks the button to generate the synchronization instruction. The synchronization option may also be provided by the right-click menu or a check box. The checked offline data is synchronized with the server data by the synchronization instruction. Thus, the user may optionally or selectively synchronize offline data to the server.

S22: sending the offline data selected by the user to the server based on the synchronization instruction. The user may choose to send all or a part of the offline data. After sending, the client does not store the synchronized offline data.

In certain embodiments, one or more steps of S207-S209 may be skipped depending on the circumstances. For example, S209 may be skipped, and the offline data is always synchronized by the automatic synchronization. S207 and S208 may be skipped, and the offline data is synchronized even in the online mode. S207-S209 may be skipped, and S210 may be performed as long as the detected network status meets normal operating conditions. Other options may also be used.

Thus, the current method/process adds the synchronization processing for the offline data. Such processing not only performs data operations in poor network condition or even when the network is disconnected to ensure smooth data operations, but also synchronizes the offline data to the server when the network conditions improve to allow complete interaction between the client and the server.

Further, the current method/process also includes at least one or more of the following steps: based on the current operation mode, prompting the user whether the operations have entered or left the offline mode; based on the current offline data synchronization, prompting the user whether the offline data is being synchronized or the offline data is not synchronized; prompting the user that the data submission is successful; and prompting the user that synchronization is completed.

The prompting may be performed using a notification window containing a notification message, or using displayed or hidden icons configured on the display interface. For example, an icon may be used to represent the offline mode. When the icon is displayed, the current mode is in the offline mode; and when the icon is hidden, the current mode is in the online mode. Based on the prompt, the user can find out the current status or any ongoing data processing. Thus, it may be more convenient for the user to determine the next operation. Further, after the data to be submitted is cached as the offline data, the user is also prompted that the data is submitted successfully according to the normal network conditions.

Further, the current method/process may also include processing steps for offline refreshing and page switching. Offline refreshing refers to operations for refreshing the display interface under the offline mode to update the contents of the display interface, and page switching refers to switching from a current page to another page. In general, when new contents are added, the current display interface still remains on the previous contents without the new contents, and only displays the new contents after refreshing the new contents obtained from the server by the client. The page switching also contains a refreshing request. Offline refreshing or page switching is performed when the network status is not desired and the client cannot communicate with the server. The offline refreshing or the page switching includes the followings.

Determining whether the user instruction is a refreshing instruction or a switching instruction. If it is determined that the user instruction is a refreshing instruction or a switching instruction, the offline data is read out. That is, in the offline mode, the client continually detects the user instruction. When the client determines that the user instruction is a refreshing instruction or a switching instruction, the cached offline data is read out.

Filling the offline data into the display page. Based on the contents of the current display page, the corresponding offline data is filled in the current display page. For example, if the current display page is a blog log list, new log title and related information are added to the log list after refreshing and the refreshed display page is displayed. The page switching also needs to refresh the content of the display page. For example, when the current page is one reading a log, any new logs will also need to be added to the log list if the current page returns to the log list page.

Further, the current method/process also includes steps for completing the data processing. The completing operation includes operations to close the client and to exit the application program. Specifically, the completing operation may include: determining whether the user instruction is an exit instruction. If the user instruction is an exit instruction, the cached offline data is stored in a memory card or other storage, and the process normally exits the current application. Because the offline data is only cached, the offline data needs to be stored in the memory card when exiting the application.

In addition, when receiving the exit instruction, the user is prompted to save the data being edited currently. This step ensures the data being edited is not lost.

FIG. 6 illustrates a system structure diagram for processing network data consistent with the disclosed embodiments. As shown in FIG. 6, the system includes a client 100 (e.g., client 706) and a server 200 (e.g., server 704). The client 100 exchanges network data with the server 200 over a network (e.g., communication network 702). The client 100 includes a network detecting module 110, a mode conversion module 120, an instruction processing module 130, a synchronization module 140, and a prompt module 150.

The network detecting module 110 is used to detect network status. The network status is a reflection of the communication status between client 100 and server 200. It may be detected by sending test packets from the client 100 to the server 200. Server response time, packet loss, data transfer rate, and other parameters determine the network status. This step may be performed throughout the method and, therefore, a change of network status may be detected at the earliest time. This step may also be scheduled at a certain time interval, that is, once every reasonable period of time. Thus, network traffic can be saved. The time interval of the scheduled detection may be adjusted according to actual situations or particular applications.

The mode conversion module 120 is used to determine whether the network status meets normal operating conditions. A normal operating condition may be defined simply as the network being in a connected status which may be determined based on whether the server 120 responds to test data packets. However, in certain applications, there are also requirements for server response time and data transfer rate for normal operating conditions. In such case, the threshold value based determination can be used, such as, whether the server response time is less than a preset threshold value; whether the data transfer rate is greater than a preset threshold data transfer rate, and so on. If it is determined that the network status does not meet the normal operating conditions, the system enters the offline mode.

The offline mode is relative to a normal online mode. A same user instruction may cause different operations to be performed in different operating modes. For example, when in the normal online mode (i.e., under a normal operating condition), the user can send the data directly to the server 200. When in the offline mode, the data may need to be cached first.

The instruction processing module 130 is used to detect one or more user instructions, further determine whether or not the user instruction is a submission instruction. If it is determined that the detected user instruction is a submission instruction, then the data to be submitted is obtained from the user and cached as offline data. Otherwise, the system continues detecting one or more user instructions.

The user instruction refers to the instruction generated by user operations. It includes a submission instruction for submitting data to be submitted, a refresh instruction for refreshing the current display interface, an exit instruction for exiting from the client, and so on. The user instructions are detected to determine corresponding operations.

The data to be submitted includes text, images, audio, video, etc. According to the client's application, each data type has its own corresponding properties. For example, when publishing a log in a Blog application, the log has a title, a body (which might contain pictures), a post or publication date, and blog categories, etc. When storing a picture (or photo), the picture (or photo) has a title, a description (notes), a post date, and photo albums categories, etc. Similarly, audio and video data also have similar properties. When the data to be submitted is cached as the offline data, the offline data is organized according to the data properties.

In certain embodiments, before entering the offline mode, the mode conversion module 120 may be used to further determine whether to enable the offline mode. The following process flow may be performed.

The mode conversion module 120 may read an offline operation flag. The offline operation flag is used to indicate whether the client 100 enables the offline mode. In general, a Boolean variable may be used to store the value of the corresponding flag. The value of offline operation flag is set or configured based on requirements from the user. The client 100 may provide an entry for such configuration, and the user selects whether to enable the offline mode and further sets the offline operation flag to a corresponding value.

The mode conversion module 120 may further determine whether to enable the offline mode based on the value of the offline operation flag. When the offline operation flag is equal to 1, which indicates that the offline mode can be used, the offline mode can be enabled to perform appropriate offline operations. On the other hand, when the offline operation flag is equal to 0, which indicates that the client does not start offline operation functionalities, the offline mode cannot be used, and all operations are processed in the traditional mode (i.e., non-offline mode).

The synchronization module 140 is used to synchronize the offline data. The synchronization module 140 detects the current operating mode when network status meets normal operating conditions, and further determines whether or not the current operating mode is an offline mode. If the current operating mode is the offline mode, the offline data is read out and sent to a server 200. The operating mode of client 100 includes the offline mode and the online mode. If network status meets the normal operating conditions and is in the offline mode, it indicates that the network status is recovered from abnormal operating conditions, and it is likely in need to synchronize the offline data. Otherwise, it indicates the network status has been under normal operating conditions, and no additional processing is needed. This is an automatic synchronization in the offline mode.

In addition, before automatically synchronizing the offline data, the synchronization module 140 determines whether to enable a manual synchronization mode. Specifically, the synchronization module 140 reads a synchronization mode flag and, based on the value of the synchronization mode flag, determines whether to enable the manual synchronization mode. The synchronization mode flag is used to indicate whether the client enables a manual synchronization mode. In general, a Boolean variable may be used to store the value of the corresponding flag. The synchronization mode flag is set based on the demand of the user.

The client may provide an entry for mode configuration. The user selects whether to enable the manual synchronization mode and further sets the synchronization mode flag to a corresponding value. When the synchronization mode flag is equal to 1, it indicates that the manual synchronization mode is enabled, and an automatic synchronization is not required. On the other hand, when the synchronization mode flag is equal to 0, it indicates that the client does not enable manual synchronization functionalities. The manual synchronization mode is not enabled, and an automatic synchronization is required.

The synchronization module 140 also includes a manual synchronization module 142 that is used to read and display the offline data and send the offline data selected by the user to the server 200 based on the synchronization instruction. The user may submit data multiple times in the offline mode, generating multiple entries of offline data. All of such offline data are read and usually displayed a list format. In the manual synchronization mode, multiple entries of offline data may be displayed in a single page using the list format.

Further, each entry of offline data is provided with a synchronization selection, which may generate the synchronization instruction when selected. The synchronization selection may be provided as a button corresponding to the offline data. The user clicks the button to generate the synchronization instruction. The synchronization option may also be provided by the right-click menu or a check box. The checked offline data is synchronized with the server data by the synchronization instruction. Thus, the user may optionally or selectively synchronize offline data to the server. The user may choose to send all or a part of the offline data. After sending, the client 100 does not store the synchronized offline data.

The prompt module 150 is used to perform at least one or more of the following operations: based on the current operation mode, prompting the user whether the operations have entered or left the offline mode; based on the current offline data synchronization, prompting the user to whether the offline data is being synchronized or the offline data is not synchronize; prompting the user that the data submission is successful; and prompting the user that synchronization is completed.

The prompting may be performed using a notification window containing a notification message, or using displayed or hidden icons configured on the display interface. For example, an icon may be used to represent the offline mode. When the icon is displayed, the current mode is in the offline mode; and when the icon is hidden, the current mode is in the online mode. Based on the prompt, the user can find out the current status or any ongoing data processing. Thus, it may be more convenient for the user to determine the next operation. Further, after the data to be submitted is cached as the offline data, the user is also prompted that the data is submitted successfully according to the normal network conditions.

Further, the instruction processing module 130 is also used to determine whether the user instruction is a refreshing instruction or a switching instruction. If it is determined that the user instruction is a refreshing instruction or a switching instruction, the offline data is read out and filled into the display page. Offline refreshing refers to operations for refreshing the display interface under the offline mode to update the contents of the display interface and page switching refers to switching from a current page to another page.

In general, when new contents are added, the current display interface still remains on the previous contents without the new contents, and only displays the new contents after refreshing the new contents obtained from the server by the client. The page switching also contains a refreshing request. Offline refreshing or page switching is performed when the network status is not desired and the client cannot communicate with the server. In the offline mode, the instruction processing module 130 continually detects the user instruction. When it is determined that the user instruction is a refreshing instruction or a switching instruction, the cached offline data is read out.

Then, instruction processing module 130 fills the offline data into the display page. Based on the contents of the current display page, the corresponding offline data is filled in the current display page. For example, if the current display page is a blog log list, new log title and related information are added to the log list after refreshing and the refreshed display page is displayed. The page switching also needs to refresh the content of the display page. For example, when the current page is one reading a log, any new logs will also need to be added to the log list if the current page returns to the log list page.

The instruction processing module 130 is also used to determine whether the user instruction is an exit instruction. If the user instruction is an exit instruction, the cached offline data is stored in a memory card or other storage, and the process normally exits the current application. The completing operation includes operations to close the client and to exit the application. Because the offline data is only cached, the offline data needs to be stored in the memory card when exiting the application. The instruction processing module 130 is also used to prompt the user to save the data being edited currently when receiving the exit instruction.

The above descriptions merely disclose certain embodiments of the present invention, and are not intended to limit the scope of the present invention. Without departing from the spirit and principles of the present invention, any modifications, equivalent replacements, and improvements, etc., should be included in the protection scope of the present invention. Therefore, the scope of the present disclosure should be defined by the attached claims.

What is claimed is:

1. A method for processing network data, including:
detecting a network status;
determining whether the network status meets one or more normal operating conditions;
when it is determined that the network status does not meet the normal operating conditions, entering an offline mode;
detecting a user instruction;
determining whether or not the user instruction is a submission instruction for submitting user data to be submitted;
when it is determined that the user instruction is a submission instruction, obtaining the user data to be submitted and caching the user data as offline data; and
when it is determined that the user instruction is not a submission instruction, continuing detecting the user instruction.

2. The method according to claim 1, wherein:
before entering the offline mode, determining whether to enable the offline mode;
when it is determined to enable the offline mode, entering the offline mode,
wherein determining whether to enable the offline mode further includes:
reading an offline operation flag; and
determining whether to enable the offline mode based on a value of the offline operation flag.

3. The method according to claim 1, further including:
synchronizing the offline data, comprising:
when the network status meets normal operating conditions, detecting a current operating mode;
determining whether the current operating mode is the offline mode; and
when it is determined that the current operating mode is the offline mode, reading the offline data and sending the offline data to a server.

4. The method according to claim 3, further including:
when the network status meets normal operating conditions and the current operating mode is the offline mode, determining whether to enable a manual synchronization mode, which further includes:
reading a synchronization mode flag; and
determining whether to enable the manual synchronization based on a value of the synchronization mode flag.

5. The method according to claim 4, wherein the manual synchronization further includes:
reading and displaying the offline data; and
sending the offline data selected by the user to the server based on a synchronization instruction.

6. The method according to claim 5, further including:
displaying multiple entries of the offline data in a single page using a list format; and
providing each entry of the offline data with a synchronization selection, which generates a synchronization instruction when selected.

7. The method according to claim 5, further including at least one of:
based on the current operation mode, prompting the user for entering or exiting the offline mode;
based on information on current offline data synchronization, prompting the user that the offline data is being synchronized or the offline data is not synchronized;
prompting the user that data submission is successful; and
prompting the user that synchronization is completed.

8. The method according to claim 1, further including:
performing offline refreshing and page switching, which further includes:
determining whether the user instruction is a refreshing instruction or a switching instruction;
when it is determined that the user instruction is a refreshing instruction or a switching instruction, reading the offline data; and
filling the offline data into a display page.

9. The method according to claim 1, further including:
completing offline data operation, which further include:
determining whether the user instruction is an exit instruction;
when it is determined that the user instruction is an exit instruction, storing the cached offline data to a memory card; and
exiting a current application.

10. The method according to claim 9, further including:
when receiving the exit instruction, saving data being currently edited.

11. A system for processing network data including a client and a server, the client exchanging network data with the server through a network, the client comprising:
a network detecting module configured to detect a network status;
a mode conversion module configured to determine whether the network status meets one or more normal operating conditions and, when it is determined that the network status does not meet the normal operating conditions, to enter an offline mode;
an instruction processing module configured to:
detect a user instruction;
determine whether or not the user instruction is a submission instruction for submitting user data to be submitted;
when it is determined that the user instruction is a submission instruction, obtain the user data to be submitted and to cache the user data as offline data; and
when it is determined that the user instruction is not a submission instruction, continue detecting the user instruction.

12. The system according to claim 11, wherein the mode conversion module is further configured to:
before entering the offline mode, determine whether to enable the offline mode; and
when it is determined to enable the offline mode, enter the offline mode,
wherein to determine whether to enable the offline mode, the mode conversion module is further configured to:
read an offline operation flag; and
determine whether to enable the offline mode based on a value of the offline operation flag.

13. The system according to claim 11, further including:
a synchronization module to synchronize the offline data and configured to:
when the network status meets normal operating conditions, detect a current operating mode;
determine whether the current operating mode is the offline mode; and
when it is determined that the current operating mode is the offline mode, read the offline data and to send the offline data to the server.

14. The system according to claim 13, wherein the synchronization module is further configured to:
when the network status meets normal operating conditions and the current operating mode is the offline mode, determine whether to enable a manual synchronization mode by:
reading a synchronization mode flag; and
determining whether to enable the manual synchronization based on a value of the synchronization mode flag.

15. The system according to claim 14, wherein in the synchronization module further includes:
a manual synchronization module configured to:
read and display the offline data; and
send the offline data selected by the user to the server based on a synchronization instruction.

16. The system according to claim 15, wherein the synchronization module is further configured to:
display multiple entries of the offline data in a single page using a list format; and
provide each entry of the offline data with a synchronization selection, which generates a synchronization instruction when selected.

17. The system according to claim 15, further including:
a prompt module configured to perform at least one of:
based on the current operation mode, prompting the user whether the operations have entered or left the offline mode;
based on the current offline data synchronization, prompting the user whether the offline data is being synchronized or the offline data is not synchronized;
prompting the user that the data submission is successful; and
prompting the user that synchronization is completed.

18. The system according to claim 11, wherein the instruction processing module is further configured to:
determine whether the user instruction is a refreshing instruction or a switching instruction;
when it is determined that the user instruction is a refreshing instruction or a switching instruction, read the offline data; and
fill the offline data into a display page.

19. The system according to claim 11, wherein the instruction processing module is further configured to:
determine whether the user instruction is an exit instruction;
when it is determined that the user instruction is an exit instruction, store the cached offline data to a memory card; and
exit a current application.

20. The system according to claim 19, wherein the instruction processing module is further configured to:
when receiving the exit instruction, save data being currently edited.
